(19) United States
(12) Patent Application Publication
(10) Pub. No.: US 2026/0276949 A1
(43) Pub. Date: Sep. 17, 2026

(54) LENS SYSTEM

(71) Applicant: Samsung Electro-Mechanics Co., Ltd., Suwon-si (KR)

(72) Inventors: Sung Bea BAN, Suwon-si (KR); Doo Hyun CHO, Suwon-si (KR); Yil HUH, Suwon-si (KR); Myung Woon KIM, Suwon-si (KR); Ji Won LEE, Suwon-si (KR); Jae Hun KIM, Suwon-si (KR)

(73) Assignee: Samsung Electro-Mechanics Co., Ltd., Suwon-si (KR)

(21) Appl. No.: 19/437,562

(22) Filed: Dec. 31, 2025

(30) Foreign Application Priority Data
Mar. 13, 2025 (KR) 10-2025-0032430

(51) Int. Cl. G02B 13/00; G02B 9/64; G02B 13/14; G02B 13/18

(52) U.S. Cl. CPC G02B 13/0005; G02B 9/64; G02B 13/14; G02B 13/18

(57) ABSTRACT

A lens system includes a first lens having a negative refractive power, a second lens having a refractive power and a concave object-side surface in a paraxial region thereof, a third lens having a refractive power, a fourth lens having a negative refractive power, a fifth lens having a refractive power, a sixth lens having a positive refractive power, a seventh lens having a refractive power, and an eighth lens having a positive refractive power, wherein the first to eighth lenses are sequentially arranged in ascending numerical order along an optical axis of the lens system away from a light source toward an imaging plane of the lens system.

### CROSS-REFERENCE TO RELATED APPLICATIONS

This application claims the benefit under 35 USC 119 (a) of Korean Patent Application No. 10-2025-0032430 filed on Mar. 13, 2025, in the Korean Intellectual Property Office, the entire disclosure of which is incorporated herein by reference for all purposes.

### BACKGROUND

### 1. Field

The present disclosure relates to a lens system that may be mounted on a laser device for processing.

### 2. Description of Background

Electronic devices include electronic components, such as printed circuit boards and multilayer capacitor components (MLCCs). These electronic components are processed using laser devices having a high processing precision. For example, via holes in printed circuit boards are formed using laser devices including F-theta lenses. Laser devices use lasers as a light source thereof. For example, laser devices generally use nanosecond lasers as a light source thereof. However, as the objects processed by laser devices become increasingly smaller and more precise, the light source of laser devices has been changed from nanosecond lasers to femtosecond lasers. Therefore, there is a need for an F-theta lens (lens system) suitable for femtosecond lasers.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens system includes a first lens having a negative refractive power; a second lens having a refractive power and a concave object-side surface in a paraxial region thereof; a third lens having a refractive power; a fourth lens having a negative refractive power; a fifth lens having a refractive power; a sixth lens having a positive refractive power; a seventh lens having a refractive power; and an eighth lens having a positive refractive power, wherein the first to eighth lenses are sequentially arranged in ascending numerical order along an optical axis of the lens system away from a light source toward an imaging plane of the lens system.

An object-side surface of the first lens may be concave in a paraxial region thereof.

An object-side surface of the third lens may be convex in a paraxial region thereof.

An object-side surface of the fourth lens may be concave in a paraxial region thereof.

An object-side surface of the fifth lens may be concave in a paraxial region thereof.

An object-side surface of the sixth lens may be convex in a paraxial region thereof.

An object-side surface of the seventh lens may be concave in a paraxial region thereof.

An object-side surface of the eighth lens may be convex in a paraxial region thereof.

In another general aspect, a lens system includes a first lens, a second lens, a third lens, a fourth lens, a fifth lens, a sixth lens, a seventh lens, and an eighth lens sequentially arranged in ascending numerical order along an optical axis of the lens system away from a light source toward an imaging plane of the lens system, wherein the second lens and the third lens each have a positive refractive power, and the lens system satisfies the conditional expression −1.5<f1/f8<−1.2, where f1 is a focal length of the first lens, and f8 is a focal length of the eighth lens.

An object-side surface of the first lens may be concave in a paraxial region thereof.

An object-side surface of the second lens may be concave in a paraxial region thereof.

An object-side surface of the third lens above may be convex in a paraxial region thereof.

An object-side surface of the fourth lens may be concave in a paraxial region thereof.

An object-side surface of the fifth lens may be concave in a paraxial region thereof.

An object-side surface of the sixth lens may be convex in a paraxial region thereof.

An object-side surface of the seventh lens may be concave in a paraxial region thereof.

An object-side surface of the eighth lens may be convex in a paraxial region thereof.

Other features and aspects will be apparent from the following detailed description, the drawings, and the claims.

### BRIEF DESCRIPTION OF DRAWINGS

FIG. 1 is a schematic diagram of a lens system according to a first embodiment.

FIG. 2 is a graph illustrating the circularity of a laser beam irradiated by the lens system of FIG. 1.

FIG. 3 is a schematic diagram of a lens system according to a second embodiment.

FIG. 4 is a graph illustrating the circularity of a laser beam irradiated by the lens system of FIG. 3.

FIG. 5 is a schematic diagram of a lens system according to a third embodiment.

FIG. 6 is a graph illustrating the circularity of a laser beam irradiated by the lens system of FIG. 5.

FIG. 7 is a schematic diagram of a lens system according to a fourth embodiment.

FIG. 8 is a graph illustrating the circularity of a laser beam irradiated by the lens system of FIG. 7.

FIG. 9 is a schematic diagram of a lens system according to a fifth embodiment.

FIG. 10 is a graph illustrating the circularity of a laser beam irradiated by the lens system of FIG. 9.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In this specification, a frontmost lens, or a first lens, refers to a lens closest to a light source (laser), and a rearmost lens, or an eighth lens, refers to a lens closest to object to be processed (or a workpiece). In this specification, object-side surface of a lens refers to a surface of the lens closest to the light source, and image-side surface of a lens refers to a surface of the lens closest to the workpiece. In this specification, the units for radiuses of curvature, thicknesses or distances, TTL (a distance from the object-side surface of the first lens to the workpiece), and focal lengths are mm.

Lens thicknesses, distances between lenses, and TTL are measured along an optical axis of a lens system.

Furthermore, in the description of a shape of a lens, a statement that a surface of the lens is convex means that a paraxial region of the surface is convex, and a statement that a surface of the lens is concave means that a paraxial region of the surface is concave. Accordingly, even when it is stated that a surface of a lens is convex, an edge portion of the surface may be concave. Similarly, even when it is stated that a surface of a lens is concave, an edge portion of the surface may be convex.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

A lens system according to the present disclosure may be used in a device using a laser. For example, the lens system according to the present disclosure may be used in a laser processing device using a nanosecond laser or a femtosecond laser as a light source. As another example, the lens system according to the present disclosure may be used in a laser measuring device using a nanosecond laser or a femtosecond laser as a light source.

The lens system according to the present disclosure may be used in a device using a galvano scanner. For example, the lens system according to the present disclosure may be used in a marking device using a galvano scanner, a processing device using a galvano scanner, or other devices using a galvano scanner.

A lens system according to a first aspect of the present disclosure may include a plurality of lenses. For example, a lens system according to the first aspect may include a first lens, a second lens, a third lens, a fourth lens, a fifth lens, a sixth lens, a seventh lens, and an eighth lens sequentially arranged in ascending numerical order along an optical axis of the lens system away from a light source (or a laser) toward an object to be processed. The lens system according to the first aspect may include lenses having a positive refractive power. For example, in the lens system according to the first aspect, the sixth lens and the eighth lens may each have a positive refractive power. The lens system according to the first aspect may include lenses having a negative refractive power. For example, in the lens system according to the first aspect, the first lens and the fourth lens may each have a negative refractive power.

A lens system according to a second aspect of the present disclosure may include a plurality of lenses. For example, the lens system according to the second aspect may include a first lens, a second lens, a third lens, a fourth lens, a fifth lens, a sixth lens, a seventh lens, and an eighth lens sequentially arranged in ascending numerical order along an optical axis of the lens system away from a light source (or a laser) toward an object to be processed. The lens system according to the second aspect may include lenses having a positive refractive power. For example, in the lens system according to the second aspect, the second and third lenses may each have a positive refractive power. The lens system according to the second aspect may satisfy a specific conditional expression. For example, the lens system according to the second aspect may satisfy a conditional expression −1.5<f1/f8<−1.2, which is denoted as Conditional Expression 1 below. In this conditional expression, f1 is a focal length of the first lens, and f8 is a focal length of the eighth lens.

A lens system according to a third aspect of the present disclosure may include a plurality of lens groups. For example, the lens system according to the third aspect may include a first lens group, a second lens group, and a third lens group. Each lens group may include a plurality of lenses. For example, the first lens group may include two lenses (the first lens and the second lens), the second lens group may include three lenses (the third lens, the fourth lens, and the fifth lens), and the third lens group may include three lenses (the sixth lens, the seventh lens, and the eighth lens).

The lenses of the lens system according to the third aspect may have specific shapes as needed. For example, the second lens group and the third lens group may be generally symmetrical. Specifically, the third lens of the second lens group may be symmetrical with the eighth lens of the third lens group, the fourth lens of the second lens group may be symmetrical with the seventh lens of the third lens group, and the fifth lens of the second lens group may be generally symmetrical with the sixth lens of the third lens group.

A lens system according to a fourth aspect of the present disclosure may include a plurality of lenses. For example, the lens system according to the fourth aspect may include a first lens, a second lens, a third lens, a fourth lens, a fifth lens, a sixth lens, a seventh lens, and an eighth lens sequentially arranged in ascending numerical order along an optical axis of the lens system away from a light source (or a laser) toward an object to be processed. The lens system according to the fourth aspect may satisfy specific conditional expressions. For example, the lens system according to the fourth aspect may satisfy any one or any combination of any two or more of the following Conditional Expressions 1 to 12:

$$- 1.5 < f 1 / f 8 < - 1.2 \qquad ( Conditional Expression 1 )$$

$$2.6 < f 2 / f 8 < 3. \qquad ( Conditional Expression 2 )$$

$$1. < f 3 / f 8 < 1.4 \qquad ( Conditional Expression 3 )$$

$$- 1.4 < f 4 / f 8 < - 1. \qquad ( Conditional Expression 4 )$$

$$1.2 < f 5 / f 8 < 1.5 \qquad ( Conditional Expression 5 )$$

$$2.3 < f 6 / f 8 < 2.6 \qquad ( Conditional Expression 6 )$$

$$- 0.9 < f 7 / f 8 < - 0.6 \qquad ( Conditional Expression 7 )$$

$$0.8 < f 1 / f 4 < 1.2 \qquad ( Conditional Expression 8 )$$

$$1.6 < f 1 / f 7 < 1.9 \qquad ( Conditional Expression 9 )$$

$$1. < f 2 / f 6 < 1.2 \qquad ( Conditional Expression 10 )$$

$$0.7 < f 3 / f 5 < 1. \qquad ( Conditional Expression 11 )$$

$$0.9 < f 2 / ( f 3 + f 5 ) < 1.2 \qquad ( Conditional Expression 12 )$$

In the above Conditional Expressions 1 to 12, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, and f8 is a focal length of the eighth lens.

The above-described Conditional Expressions 1 to 12 are numerical ranges for specifying ratios of refractive powers of the first to eighth lenses. For example, first to eighth lenses falling outside the numerical ranges of the above-described Conditional Expressions 1 to 12 may have minimal aberration improvement effects.

A lens system according to a fifth aspect of the present disclosure may include a plurality of lenses. For example, the lens system according to the fifth aspect may include a first lens, a second lens, a third lens, a fourth lens, a fifth lens, a sixth lens, a seventh lens, and an eighth lens sequentially arranged in ascending numerical order along an optical axis of the lens system away from a light source (or a laser) toward an object to be processed. The lens system according to the fifth aspect may satisfy specific conditional expressions. For example, the lens system according to the fifth aspect may satisfy any one or any combination of any two or more of the following Conditional Expressions 13 to 15:

$$0.4 < TTL / fb < 0.6 \qquad ( Conditional Expression 13 )$$

$$0.6 < TTL / f 2 < 0.9 \qquad ( Conditional Expression 14 )$$

$$2. < TTL / f 8 < 2.4 \qquad ( Conditional Expression 15 )$$

In the above Conditional Expressions 13 to 15, TTL represents a distance along the optical axis from the object-side surface of the first lens to the workpiece, and fb represents a rear focal length of the lens system, which is a distance along the optical axis from the image-side surface of the eighth lens to the workpiece, The above Conditional Expressions 13 to 15 are numerical ranges for specifying the length and rear focal length of the lens system according to the fifth aspect. For example, a lens system falling outside the numerical ranges of the above Conditional Expressions 13 to 15 may have a TTL that is too large, making it difficult for the lens system to be mounted in a laser device. In another example, a lens system outside the numerical ranges of the above Conditional Expressions 13 to 15 may have a rear focal length that is too large or too small, making it difficult to precisely process the workpiece.

A lens system according to a sixth aspect of the present disclosure may include a plurality of lenses. For example, the lens system according to the sixth aspect may include a first lens, a second lens, a third lens, a fourth lens, a fifth lens, a sixth lens, a seventh lens, and an eighth lens sequentially arranged in ascending numerical order along an optical axis of the lens system away from a light source (or a laser) toward an object to be processed. The lens system according to the sixth aspect may satisfy specific conditional expressions. For example, the lens system according to the sixth aspect may satisfy any one or any combination of any two or more of the following Conditional Expressions 16 to 19:

$$- 0.6 < R 1 / f 5 < - 0.2 \qquad ( Conditional Expression 16 )$$

$$- 1. < R 16 / f 5 < - 0.6 \qquad ( Conditional Expression 17 )$$

$$- 2.4 < ( R 1 + R 16 ) / ( R 1 - 16 ) < - 1.8 \qquad ( Conditional Expression 18 )$$

$$- 20 < ( R 6 + R 7 ) / ( R 6 - R 7 ) < - 16 \qquad ( Conditional Expression 19 )$$

In the above-described Conditional Expressions 16 to 19, R1 represents a radius of curvature of an object-side surface of the first lens, R6 represents a radius of curvature of an image-side surface of the third lens, R7 represents a radius of curvature of an object-side surface of the fourth lens, and R16 represents a radius of curvature of an image-side surface of the eighth lens. The above-described Conditional Expressions 16 to 19 are numerical ranges for optimizing the shapes of the first, third, fourth, and eighth lenses. For example, first, third, fourth, and eighth lenses satisfying the above-described Conditional Expressions 16 to 19 may effectively improve aberrations in the lens system.

A lens system according to a seventh aspect of the present disclosure may include a plurality of lenses. For example, the lens system according to the seventh aspect may include a first lens, a second lens, a third lens, a fourth lens, a fifth lens, a sixth lens, a seventh lens, and an eighth lens sequentially arranged in ascending numerical order along an optical axis of the lens system away from a light source (or a laser) toward an object to be processed. The lens system according to the seventh aspect may satisfy specific conditional expressions. For example, the lens system according to the seventh aspect may satisfy any one or any combination of any two or more of the following Conditional Expressions 20 to 22:

$$0.86 < SumV 14 / SumV 58 < 0 \text{.96} \qquad ( Conditional Expression 20 )$$

$$1. < S umV 35 / SumV 68 < 1.2 \qquad ( Conditional Expression 21 )$$

$$2. < Su mVP / SumVN < 2.1 \qquad ( Conditional Expression 22 )$$

In the above-described Conditional Expressions 20 to 22, SumV14 is the sum of the Abbe numbers of the first to fourth lenses, SumV58 is the sum of the Abbe numbers of the fifth to eighth lenses, SumV35 is the sum of the Abbe numbers of the third to fifth lenses, SumV68 is the sum of the Abbe numbers of the sixth to eighth lenses, SumVP is the sum of the Abbe numbers of the lenses having a positive refractive power among the first to eighth lenses, and SumVN is the sum of the Abbe numbers of the lenses having a negative refractive power among the first to eighth lenses. The above-described Conditional Expressions 20 to 22 are numerical ranges for improving aberrations of the lens system.

A lens system according to an eighth aspect of the present disclosure may include two or more of the features of the lens systems according to the above-described aspects. For example, the lens system according to the eighth aspect may include the features of the first aspect and satisfy any one or any combination of any two or more of the conditional expressions according to the fourth to seventh aspects. In another example, the lens system according to the eighth aspect may include the features of the second aspect and satisfy any one or any combination of any two or more of the conditional expressions according to the fourth to seventh aspects.

The lens systems according to the present disclosure may include one or more lenses having the characteristics described below as needed. For example, the lens system according to the first aspect may include one of the first to eighth lenses having the characteristics described below. In another example, the lens systems according to the second to seventh aspects may include one or more of the first to eighth lenses having the characteristics described below. However, the lens systems according to the aforementioned aspects do not necessarily include the lenses having the characteristics described below. The characteristics of the first to eighth lenses are described below.

The first lens may have a predetermined refractive power. For example, the first lens may have a negative refractive power. The first lens may have a surface that is concave in a paraxial region thereof. For example, an object-side surface of the first lens may be concave in a paraxial region thereof. The first lens may have a predetermined refractive index and a predetermined Abbe number. For example, the refractive index of the first lens may be 1.5 or less, and the Abbe number of the first lens may be 65 or greater.

The second lens may have a predetermined refractive power. For example, the second lens may have a positive refractive power. The second lens may have a surface that is concave in a paraxial region thereof. For example, an object-side surface of the second lens may be concave in a paraxial region thereof. The second lens may have a predetermined refractive index and a predetermined Abbe number. For example, the refractive index of the second lens may be 1.5 or less, and the Abbe number of the second lens may be 65 or greater.

The third lens may have a predetermined refractive power. For example, the third lens may have a positive refractive power. The third lens may have a surface that is convex in a paraxial region thereof. For example, an object-side surface of the third lens may be convex in a paraxial region thereof. The third lens may have a predetermined refractive index and a predetermined Abbe number. For example, the refractive index of the third lens may be 1.5 or less, and the Abbe number may be 90 or greater.

The fourth lens may have a predetermined refractive power. For example, the fourth lens may have a negative refractive power. The fourth lens may have a surface that is concave in a paraxial region thereof. For example, an object-side surface of the fourth lens may be concave in a paraxial region thereof. The fourth lens may have a predetermined refractive index and a predetermined Abbe number. For example, the refractive index of the fourth lens may be 1.5 or less, and the Abbe number of the fourth lens may be 65 or greater.

The fifth lens may have a predetermined refractive power. For example, the fifth lens may have a positive refractive power. The fifth lens may have a surface that is concave in a paraxial region thereof. For example, an object-side surface of the fifth lens may be concave in a paraxial region thereof. The fifth lens may have a predetermined refractive index and a predetermined Abbe number. For example, the refractive index of the fifth lens may be 1.5 or less, and the Abbe number of the fifth lens may be 90 or greater.

The sixth lens may have a predetermined refractive power. For example, the sixth lens may have a positive refractive power. The sixth lens may have a surface that is convex in a paraxial region thereof. For example, an object-side surface of the sixth lens may be convex in a paraxial region thereof. The sixth lens may have a predetermined refractive index and a predetermined Abbe number. For example, the refractive index of the sixth lens may be 1.5 or less, and the Abbe number of the sixth lens may be 65 or greater.

The seventh lens may have a predetermined refractive power. For example, the seventh lens may have a negative refractive power. The seventh lens may have a surface that is concave in a paraxial region thereof. For example, an object-side surface of the seventh lens may be concave in a paraxial region thereof. The seventh lens may have a predetermined refractive index and a predetermined Abbe number. For example, the refractive index of the seventh lens may be 1.5 or less, and the Abbe number of the seventh lens may be 65 or greater.

The eighth lens may have a predetermined refractive power. For example, the eighth lens may have a positive refractive power. The eighth lens may have a surface that is convex in a paraxial region thereof. For example, an object-side surface of the eighth lens may be convex in a paraxial region thereof. The eighth lens may have a predetermined refractive index and a predetermined Abbe number. For example, the refractive index of the eighth lens may be 1.5 or less, and the Abbe number of the eighth lens may be 90 or greater.

The first to eighth lenses according to an embodiment of the present disclosure may be configured to be suitable for a high-power laser processing device. For example, the surfaces of the first to eighth lenses may be coated using ion beam sputtering (IBS). In another example, the surfaces of the first to eighth lenses may be coated with a material that will not be damaged by ultraviolet (UV) light.

Hereinafter, embodiments of the present disclosure will be described in detail with reference to the accompanying drawings.

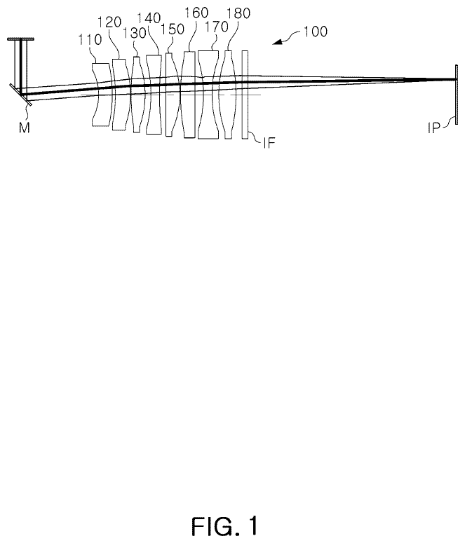

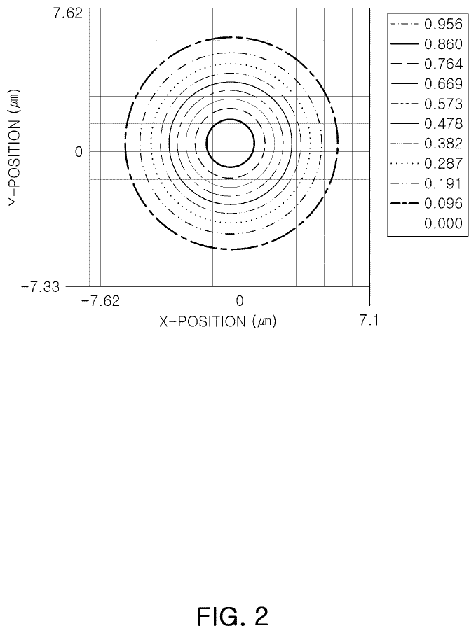

FIG. 1 is a schematic diagram of a lens system according to a first embodiment, and FIG. 2 is a graph illustrating the circularity of a laser beam irradiated by the lens system of FIG. 1.

Referring to FIG. 1, a lens system 100 according to the present embodiment may include a plurality of lenses sequentially arranged along an optical axis of the lens system 100 away from a light source toward an imaging plane IP of the lens system 100. For example, the lens system 100 according to the present embodiment may include a first lens 110, a second lens 120, a third lens 130, a fourth lens 140, a fifth lens 150, a sixth lens 160, a seventh lens 170, and an eighth lens 180 sequentially arranged in ascending numerical order along the optical axis of the lens system 100 away from a light source toward the imaging plane IP of the lens system 100. The first lens 110 to the eighth lens 180 may have predetermined refractive powers and shapes. For example, the first lens 110 may have a negative refractive power, a concave object-side surface in a paraxial region thereof, and a convex image-side surface in a paraxial region thereof, the second lens 120 may have a positive refractive power, a concave object-side surface in a paraxial region thereof, a convex image-side surface in a paraxial region thereof, the third lens 130 may have a positive refractive power, a convex object-side surface in a paraxial region thereof, and a convex image-side surface in a paraxial region thereof, the fourth lens 140 may have a negative refractive power, a concave object-side surface in a paraxial region thereof, and a concave image-side surface in a paraxial region thereof, the fifth lens 150 may have a positive refractive power, a concave object-side surface in a paraxial region thereof, and a convex image-side surface in a paraxial region thereof, the sixth lens 160 may have a positive refractive power, and a convex object-side surface in a paraxial region thereof, and a convex image-side surface in a paraxial region thereof, the seventh lens 170 may have a negative refractive power, a concave object-side surface in a paraxial region thereof, and a concave image-side surface in a paraxial region thereof, and the eighth lens 180 may have a positive refractive power, a convex object-side surface in a paraxial region thereof, and a convex image-side surface in a paraxial region thereof.

The lens system 100 according to the present embodiment may be divided into three lens groups. For example, the lens system 100 may include a first lens group including the first lens 110 and the second lens 120, a second lens group including the third lens 130 to the fifth lens 150, and a third lens group including the sixth lens 160 to the eighth lens 180. The first to third lens groups may be configured to perform a corrective function. For example, the first lens 110 and the second lens 120 of the first lens group may serve to expand light incident from a light source (a femtosecond laser), while the third lens 130 to the eighth lens 180 of the second and third lens groups may serve to remove chromatic aberration from the incident light.

The lens system 100 according to the present embodiment may further include other components in addition to the first lens 110 to the eighth lens 180. For example, the lens system 100 may further include a reflector M reflecting light from a light source onto the object-side surface of the first lens 110. As another example, the lens system 100 may further include a protective glass or filter IF disposed between the image-side surface of the eighth lens 180 and the imaging plane IP. For reference, the imaging plane IP is a surface of a processing device on which a processing surface (or a surface to be processed) or a workpiece is secured.

The lens system 100 configured as described above may uniformly focus a femtosecond laser on the imaging plane IP. For example, the lens system 100 according to the present embodiment may converge all wavelengths of the femtosecond laser into a generally uniform or consistent shape (circular) as illustrated in FIG. 2. Therefore, the lens system 100 according to the present embodiment may improve the processing precision of a laser processing device and significantly reduce a processing deviation. For reference, the X-position and the Y-position illustrated in FIG. 2 represent first and second directions of the processing surface intersecting the optical axis of the lens system 100.

Table 1 below illustrates the lens characteristics of the lens system 100 according to the present embodiment.

TABLE 1

| Surface | | Radius of | Thickness/ | Effective | Refractive | Abbe |
|---|---|---|---|---|---|---|
| No. | Component | Curvature | Distance | Radius | Index | Number |
| S1 | First | −26.360 | 6.500 | 12.132 | 1.458 | 67.821 |
| S2 | Lens | −67.680 | 1.250 | 13.929 | | |
| S3 | Second | −85.360 | 7.500 | 14.253 | 1.458 | 67.821 |
| S4 | Lens | −46.840 | 0.500 | 15.341 | | |
| S5 | Third | 154.080 | 6.410 | 15.839 | 1.434 | 94.996 |
| S6 | Lens | −53.340 | 3.000 | 16.164 | | |
| S7 | Fourth | −59.600 | 4.000 | 16.168 | 1.458 | 67.821 |
| S8 | Lens | 147.100 | 3.000 | 16.683 | | |
| S9 | Fifth | −1849.500 | 6.580 | 17.054 | 1.434 | 94.996 |
| S10 | Lens | −44.050 | 0.500 | 17.518 | | |
| S11 | Sixth | 97.100 | 7.000 | 17.551 | 1.458 | 67.821 |
| S12 | Lens | −646.660 | 4.000 | 17.411 | | |
| S13 | Seventh | −55.780 | 4.000 | 17.251 | 1.458 | 67.821 |
| S14 | Lens | 51.710 | 3.000 | 17.625 | | |
| S15 | Eighth | 55.620 | 8.600 | 18.316 | 1.434 | 94.996 |
| S16 | Lens | −76.630 | 3.000 | 18.547 | | |
| S17 | Filter | Infinity | 2.500 | 18.429 | | |
| S18 | | Infinity | 100.000 | 18.388 | | |
| S19 | Surface to Be | | 0.000 | 14.138 | | |
| | Processed | | | | | |

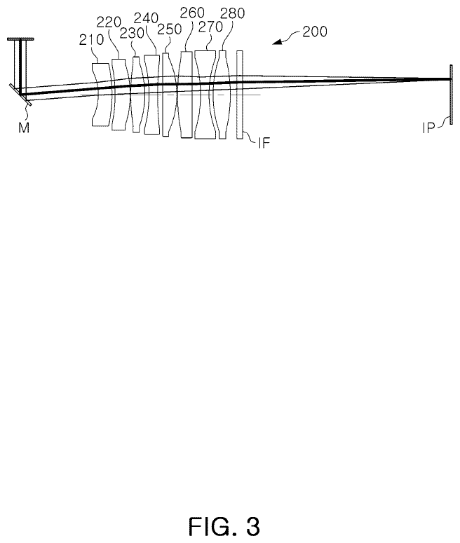

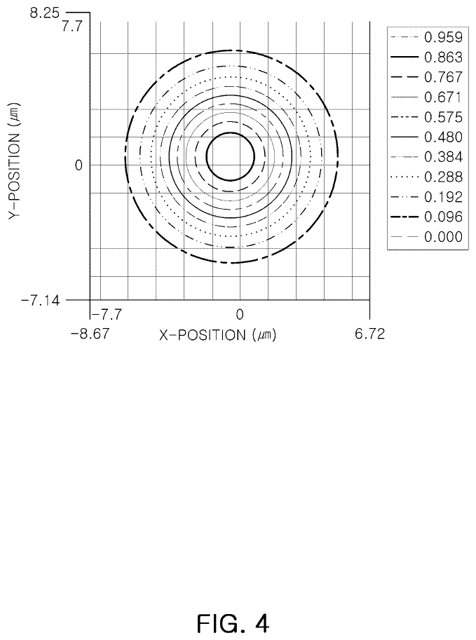

FIG. 3 is a schematic diagram of a lens system according to a second embodiment, and FIG. 4 is a graph illustrating the circularity of a laser beam irradiated by the lens system of FIG. 3.

Referring to FIG. 3, a lens system 200 according to the present embodiment may include a plurality of lenses sequentially arranged along an optical axis of the lens system 200 away from a light source toward an imaging plane IP of the lens system 200. For example, the lens system 200 according to the present embodiment may include a first lens 210, a second lens 220, a third lens 230, a fourth lens 240, a fifth lens 250, a sixth lens 260, a seventh lens 270, and an eighth lens 280 sequentially arranged in ascending numerical order along the optical axis of the lens system 200 away from a light source toward the imaging plane IP of the lens system 200. The first lens 210 to the eighth lens 280 may have predetermined refractive powers and shapes. For example, the first lens 210 may have a negative refractive power, a concave object-side surface in a paraxial region thereof, and a convex image-side surface in a paraxial region thereof, the second lens 220 may have a positive refractive power, a concave object-side surface in a paraxial region thereof, and a convex image-side surface in a paraxial region thereof, the third lens 230 may have a positive refractive power, a convex object-side surface in a paraxial region thereof, and a convex image-side surface in a paraxial region thereof, the fourth lens 240 may have a negative refractive power, a concave object-side surface in a paraxial region thereof, and a concave image-side surface in a paraxial region thereof, the fifth lens 250 may have a positive refractive power, a concave object-side surface in a paraxial region thereof, and a convex image-side surface in a paraxial region thereof, the sixth lens 260 may have a positive refractive power, a convex object-side surface in a paraxial region thereof, and a convex image-side surface in a paraxial region thereof, the seventh lens 270 may have a negative refractive power, a concave object-side surface in a paraxial region thereof, and a concave image-side surface in a paraxial region thereof, and the eighth lens 280 may have a positive refractive power, a convex object-side surface in a paraxial region thereof, and a convex image-side surface in a paraxial region thereof.

The lens system 200 according to the present embodiment may be divided into three lens groups. For example, the lens system 200 may include a first lens group including the first lens 210 and the second lens 220, a second lens group including the third lens 230 to the fifth lens 250, and a third lens group including the sixth lens 260 to the eighth lens 280. The first to third lens groups may be configured to perform a corrective function. For example, the first lens 210 and the second lens 220 of the first lens group may serve to expand light incident from a light source (a femtosecond laser), while the third lens 230 to the eighth lens 280 of the second and third lens groups may serve to remove chromatic aberration from the incident light.

The lens system 200 according to the present embodiment may further include other components in addition to the first lens 210 to the eighth lens 280. For example, the lens system 200 may further include a reflector M reflecting light from a light source onto the object-side surface of the first lens 210. As another example, the lens system 200 may further include a protective glass or filter IF disposed between the image-side surface of the eighth lens 280 and the imaging plane IP. For reference, the imaging plane IP is a surface of a processing device on which a processing surface (or a surface to be processed) or a workpiece is secured.

The lens system 200 configured as described above may uniformly focus a femtosecond laser on the imaging plane IP. For example, the lens system 200 according to the present embodiment may converge all wavelengths of the femtosecond laser into a generally uniform or consistent shape (circular) as illustrated in FIG. 4. Therefore, the lens system 200 according to the present embodiment may improve the processing precision of a laser processing device and significantly reduce a processing deviation. For reference, the X-position and the Y-position illustrated in FIG. 4 represent first and second directions of the processing surface intersecting the optical axis of the lens system 200.

Table 2 below illustrates the lens characteristics of the lens system 200 according to the present embodiment.

TABLE 2

| Surface | | Radius of | Thickness/ | Effective | Refractive | Abbe |
|---|---|---|---|---|---|---|
| No. | Component | Curvature | Distance | Radius | Index | Number |
| S1 | First | −26.363 | 6.593 | 12.132 | 1.458 | 67.821 |
| S2 | Lens | −67.794 | 1.254 | 13.929 | | |
| S3 | Second | −85.188 | 7.533 | 14.253 | 1.458 | 67.821 |
| S4 | Lens | −46.852 | 0.500 | 15.341 | | |
| S5 | Third | 154.264 | 6.319 | 15.839 | 1.434 | 94.996 |
| S6 | Lens | −53.428 | 2.386 | 16.164 | | |
| S7 | Fourth | −59.644 | 4.000 | 16.168 | 1.458 | 67.821 |
| S8 | Lens | 147.014 | 2.542 | 16.683 | | |
| S9 | Fifth | −1580.790 | 6.631 | 17.054 | 1.434 | 94.996 |
| S10 | Lens | −43.772 | 0.500 | 17.518 | | |
| S11 | Sixth | 97.026 | 6.997 | 17.551 | 1.458 | 67.821 |
| S12 | Lens | −662.572 | 4.015 | 17.411 | | |
| S13 | Seventh | −55.608 | 4.000 | 17.251 | 1.458 | 67.821 |
| S14 | Lens | 51.962 | 2.177 | 17.625 | | |
| S15 | Eighth | 54.767 | 8.393 | 18.316 | 1.434 | 94.996 |
| S16 | Lens | −77.930 | 3.110 | 18.547 | | |
| S17 | Filter | Infinity | 2.646 | 18.429 | | |
| S18 | | Infinity | 100.000 | 18.388 | | |
| S19 | Surface to Be | | 0.000 | 14.138 | | |
| | Processed | | | | | |

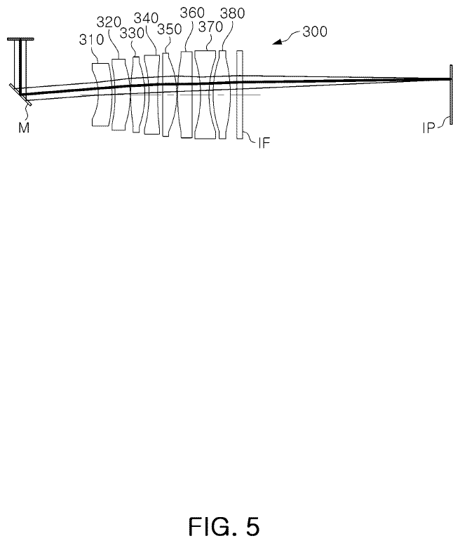

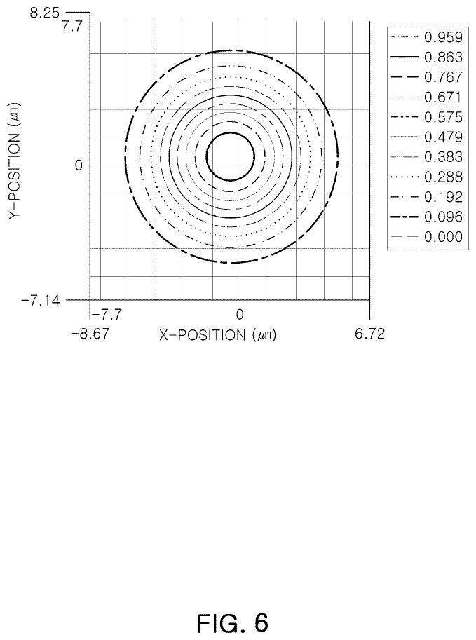

FIG. 5 is a schematic diagram of a lens system according to a third embodiment, and FIG. 6 is a graph illustrating the circularity of a laser beam irradiated by the lens system of FIG. 5.

Referring to FIG. 5, a lens system 300 according to the present embodiment may include a plurality of lenses sequentially arranged along an optical axis of the lens system 300 away from a light source toward an imaging plane IP of the lens system 300. For example, the lens system 300 according to the present embodiment may include a first lens 310, a second lens 320, a third lens 330, a fourth lens 340, a fifth lens 350, a sixth lens 360, a seventh lens 370, and an eighth lens 380 sequentially arranged in ascending numerical order along the optical axis of the lens system 300 away from a light source toward the imaging plane IP of the lens system 300. The first lens 310 to the eighth lens 380 may have predetermined refractive powers and shapes. For example, the first lens 310 may have a negative refractive power, and a concave object-side surface in a paraxial region thereof, and a convex image-side surface in a paraxial region thereof, the second lens 320 may have a positive refractive power, a concave object-side surface in a paraxial region thereof, and a convex image-side surface in a paraxial region thereof, the third lens 330 may have a positive refractive power, a convex object-side surface in a paraxial region thereof, and a convex image-side surface in a paraxial region thereof, the fourth lens 340 may have a negative refractive power, a concave object-side surface in a paraxial region thereof, and a concave image-side surface in a paraxial region thereof, the fifth lens 350 may have a positive refractive power, a concave object-side surface in a paraxial region thereof, and a convex image-side surface in a paraxial region thereof, the sixth lens 360 may have a positive refractive power, and a convex object-side surface in a paraxial region thereof, and a convex image-side surface in a paraxial region thereof, the seventh lens 370 may have a negative refractive power, a concave object-side surface in a paraxial region thereof, and a concave image-side surface in a paraxial region thereof, and the eighth lens 380 may have a positive refractive power, a convex object-side surface in a paraxial region thereof, and a convex image-side surface in a paraxial region thereof.

The lens system 300 according to the present embodiment may be divided into three lens groups. For example, the lens system 300 may include a first lens group including the first lens 310 and the second lens 320, a second lens group including the third lens 330 to the fifth lens 350, and a third lens group including the sixth lens 360 to the eighth lens 380. The first to third lens groups may be configured to perform a corrective function. For example, the first lens 310 and the second lens 320 of the first lens group may serve to expand light incident from a light source (a femtosecond laser), while the third lens 330 to the eighth lens 380 of the second and third lens groups may serve to remove chromatic aberration from the incident light.

The lens system 300 according to the present embodiment may further include other components in addition to the first lens 310 to the eighth lens 380. For example, the lens system 300 may further include a reflector M reflecting light from a light source onto the object-side surface of the first lens 310. As another example, the lens system 300 may further include a protective glass or filter IF disposed between the image-side surface of the eighth lens 380 and the imaging plane IP. For reference, the imaging plane IP is a surface of a processing device on which a processing surface (or a surface to be processed) or a workpiece is secured.

The lens system 300 configured as described above may uniformly focus a femtosecond laser on the imaging plane IP. For example, the lens system 300 according to the present embodiment may converge all wavelengths of the femtosecond laser into a generally uniform or consistent shape (circular) as illustrated in FIG. 6. Therefore, the lens system 300 according to the present embodiment may improve the processing precision of a laser processing device and significantly reduce a processing deviation. For reference, the X-position and the Y-position shown in FIG. 6 represent first and second directions of the processing surface intersecting the optical axis of the lens system 300.

Table 3 below illustrates the lens characteristics of the lens system 300 according to the present embodiment.

TABLE 3

| Surface | | Radius of | Thickness/ | Effective | Refractive | Abbe |
|---|---|---|---|---|---|---|
| No. | Component | Curvature | Distance | Radius | Index | Number |
| S1 | First | −26.363 | 6.657 | 12.132 | 1.458 | 67.821 |
| S2 | Lens | −67.802 | 1.254 | 13.929 | | |
| S3 | Second | −85.199 | 7.491 | 14.253 | 1.458 | 67.821 |
| S4 | Lens | −46.860 | 0.499 | 15.341 | | |
| S5 | Third | 154.229 | 6.318 | 15.839 | 1.434 | 94.996 |
| S6 | Lens | −53.458 | 2.200 | 16.164 | | |
| S7 | Fourth | −59.716 | 4.000 | 16.168 | 1.458 | 67.821 |
| S8 | Lens | 146.619 | 2.546 | 16.683 | | |
| S9 | Fifth | −1558.067 | 6.568 | 17.054 | 1.434 | 94.996 |
| S10 | Lens | −43.740 | 0.500 | 17.518 | | |
| S11 | Sixth | 97.251 | 7.025 | 17.551 | 1.458 | 67.821 |
| S12 | Lens | −651.332 | 4.011 | 17.411 | | |
| S13 | Seventh | −55.623 | 4.000 | 17.251 | 1.458 | 67.821 |
| S14 | Lens | 51.968 | 1.937 | 17.625 | | |
| S15 | Eighth | 54.426 | 8.396 | 18.316 | 1.434 | 94.996 |
| S16 | Lens | −78.558 | 3.124 | 18.547 | | |
| S17 | Filter | Infinity | 2.661 | 18.429 | | |
| S18 | | Infinity | 100.000 | 18.388 | | |
| S19 | Surface to Be | | 0.000 | 14.138 | | |
| | Processed | | | | | |

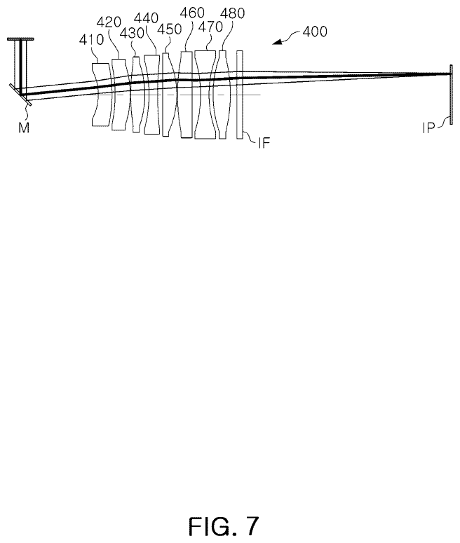

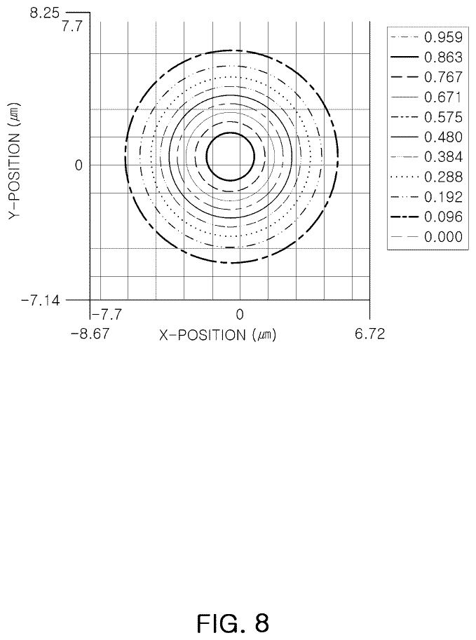

FIG. 7 is a schematic diagram of a lens system according to a fourth embodiment, and FIG. 8 is a graph illustrating the circularity of a laser beam irradiated by the lens system of FIG. 7.

Referring to FIG. 7, a lens system 400 according to the present embodiment may include a plurality of lenses sequentially arranged along an optical axis of the lens system 400 away from a light source toward an imaging plane IP of the lens system 400. For example, the lens system 400 according to the present embodiment may include a first lens 410, a second lens 420, a third lens 430, a fourth lens 440, a fifth lens 450, a sixth lens 460, a seventh lens 470, and an eighth lens 480 sequentially arranged along the optical axis of the lens system 400 away from a light source toward the imaging plane IP of the lens system 400. The first lens 410 to the eighth lens 480 may have predetermined refractive powers and shapes. For example, the first lens 410 may a have negative refractive power, a concave object-side surface in a paraxial region thereof, and a convex image-side surface in a paraxial region thereof, the second lens 420 may have a positive refractive power, a concave object-side surface in a paraxial region thereof, and a convex image-side surface in a paraxial region thereof, the third lens 430 may have a positive refractive power, a convex object-side surface in a paraxial region thereof, and a convex image-side surface in a paraxial region thereof, the fourth lens 440 may have a negative refractive power, a concave object-side surface in a paraxial region thereof, and a concave image-side surface in a paraxial region thereof, the fifth lens 450 may have a positive refractive power, a concave object-side surface in a paraxial region thereof, and a convex image-side surface in a paraxial region thereof, the sixth lens 460 may have a positive refractive power, a convex object-side surface in a paraxial region thereof, and a convex image-side surface in a paraxial region thereof, the seventh lens 470 may have a negative refractive power, a concave object-side surface in a paraxial region thereof, and a concave image-side surface in a paraxial region thereof, and the eighth lens 480 may have a positive refractive power, a convex object-side surface in a paraxial region thereof, and a convex image-side surface in a paraxial region thereof.

The lens system 400 according to the present embodiment may be divided into three lens groups. For example, the lens system 400 may include a first lens group including the first lens 410 and the second lens 420, a second lens group including the third lens 430 to the fifth lens 450, and a third lens group including the sixth lens 460 to the eighth lens 480. The first to third lens groups may be configured to perform a corrective function. For example, the first lens 410 and the second lens 420 of the first lens group may serve to expand light incident from a light source (a femtosecond laser), while the third lens 430 to the eighth lens 480 of the second and third lens groups may serve to remove chromatic aberration from the incident light.

The lens system 400 according to the present embodiment may further include other components in addition to the first lens 410 to the eighth lens 480. For example, the lens system 400 may further include a reflector M reflecting light from a light source onto the object-side surface of the first lens 410. As another example, the lens system 400 may further include a protective glass or filter IF disposed between the image-side surface of the eighth lens 480 and the imaging plane IP. For reference, the imaging plane IP is a surface of a processing device on which a processing surface (or a surface to be processed) or a workpiece is secured.

The lens system 400 configured as described above may uniformly focus a femtosecond laser on the imaging plane IP. For example, the lens system 400 according to the present embodiment may converge all wavelengths of the femtosecond laser into a generally uniform or consistent shape (circular) as illustrated in FIG. 8. Therefore, the lens system 400 according to the present embodiment may improve the processing precision of a laser processing device and significantly reduce a processing deviation. For reference, the X-position and the Y-position shown in FIG. 8 represent first and second directions of the processing surface intersecting the optical axis of the lens system 400.

Table 4 below illustrates the lens characteristics of the lens system 400 according to the present embodiment.

TABLE 4

| Surface | | Radius of | Thickness/ | Effective | Refractive | Abbe |
|---|---|---|---|---|---|---|
| No. | Component | Curvature | Distance | Radius | Index | Number |
| S1 | First | −26.363 | 6.713 | 12.132 | 1.458 | 67.821 |
| S2 | Lens | −67.775 | 1.255 | 13.929 | | |
| S3 | Second | −85.139 | 7.458 | 14.253 | 1.458 | 67.821 |
| S4 | Lens | −46.835 | 0.500 | 15.341 | | |
| S5 | Third | 154.034 | 6.317 | 15.839 | 1.434 | 94.996 |
| S6 | Lens | −53.504 | 2.111 | 16.164 | | |
| S7 | Fourth | −59.796 | 4.000 | 16.168 | 1.458 | 67.821 |
| S8 | Lens | 146.136 | 2.547 | 16.683 | | |
| S9 | Fifth | −1583.194 | 6.568 | 17.054 | 1.434 | 94.996 |
| S10 | Lens | −43.754 | 0.500 | 17.518 | | |
| S11 | Sixth | 97.523 | 7.039 | 17.551 | 1.458 | 67.821 |
| S12 | Lens | −639.531 | 4.005 | 17.411 | | |
| S13 | Seventh | −55.671 | 4.000 | 17.251 | 1.458 | 67.821 |
| S14 | Lens | 51.930 | 1.788 | 17.625 | | |
| S15 | Eighth | 54.155 | 8.397 | 18.316 | 1.434 | 94.996 |
| S16 | Lens | −79.104 | 3.120 | 18.547 | | |
| S17 | Filter | Infinity | 2.654 | 18.429 | | |
| S18 | | Infinity | 100.000 | 18.388 | | |
| S19 | Surface to Be | | 0.000 | 14.138 | | |
| | Processed | | | | | |

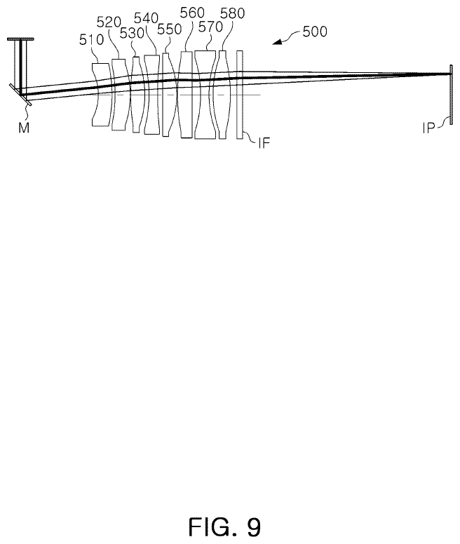

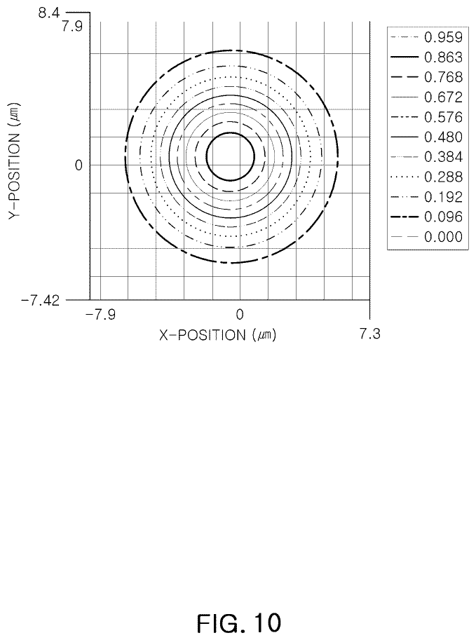

FIG. 9 is a schematic diagram of a lens system according to a fifth embodiment, and FIG. 10 is a graph illustrating the circularity of a laser beam irradiated by the lens system of FIG. 9.

Referring to FIG. 9, a lens system 500 according to the present embodiment may include a plurality of lenses sequentially arranged along an optical axis of the lens system 500 away from a light source toward an imaging plane IP of the lens system 500. For example, the lens system 500 according to the present embodiment may include a first lens 510, a second lens 520, a third lens 530, a fourth lens 540, a fifth lens 550, a sixth lens 560, a seventh lens 570, and an eighth lens 580 sequentially arranged along the optical axis of the lens system 500 away from a light source toward the imaging plane IP of the lens system 500. The first lens 510 to the eighth lens 580 may have predetermined refractive powers and shapes. For example, the first lens 510 may have a negative refractive power, a concave object-side surface in a paraxial region thereof, and a convex image-side surface in a paraxial region thereof, the second lens 520 may have a positive refractive power, a concave object-side surface in a paraxial region thereof, and a convex image-side surface in a paraxial region thereof, the third lens 530 may have a positive refractive power, a convex object-side surface in a paraxial region thereof, and a convex image-side surface in a paraxial region thereof, the fourth lens 540 may have a negative refractive power, a concave object-side surface in a paraxial region thereof, and a concave image-side surface in a paraxial region thereof, the fifth lens 550 may have a positive refractive power, a concave object-side surface in a paraxial region thereof, and a convex image-side surface in a paraxial region thereof, the sixth lens 560 may have a positive refractive power, a convex object-side surface in a paraxial region thereof, and a convex image-side surface in a paraxial region thereof, the seventh lens 570 may have a negative refractive power, a concave object-side surface in a paraxial region thereof, and a concave image-side surface in a paraxial region thereof, and the eighth lens 580 may have a positive refractive power, a convex object-side surface in a paraxial region thereof, and a convex image-side surface in a paraxial region thereof.

The lens system 500 according to the present embodiment may be divided into three lens groups. For example, the lens system 500 may include a first lens group including the first lens 510 and the second lens 520, a second lens group including the third lens 530 to the fifth lens 550, and a third lens group including the sixth lens 560 to the eighth lens 580. The first to third lens groups may be configured to perform a corrective function. For example, the first lens 510 and the second lens 520 of the first lens group may serve to expand light incident from a light source (a femtosecond laser), while the third lens 530 to the eighth lens 580 of the second and third lens groups may serve to remove chromatic aberration from the incident light.

The lens system 500 according to the present embodiment may further include other components in addition to the first lens 510 to the eighth lens 580. For example, the lens system 500 may further include a reflector M reflecting light from a light source onto the object-side surface of the first lens 510. As another example, the lens system 500 may further include a protective glass or filter IF disposed between the image-side surface of the eighth lens 580 and the imaging plane IP. For reference, the imaging plane IP is a surface of a processing device on which a processing surface (or a surface to be processed) or a workpiece is secured.

The lens system 500 configured as described above may uniformly focus a femtosecond laser on the imaging plane IP. For example, the lens system 500 according to the present embodiment may converge all wavelengths of the femtosecond laser into a generally uniform or consistent shape (circular), as illustrated in FIG. 10. Therefore, the lens system 500 according to the present embodiment may improve the processing precision of a laser processing device and significantly reduce a processing deviation. For reference, the X-position and the Y-position illustrated in FIG. 10 represent first and second directions of the processing surface intersecting the optical axis of the lens system 500.

Table 5 below illustrates the lens characteristics of the lens system 500 according to the present embodiment.

TABLE 5

| Surface | | Radius of | Thickness/ | Effective | Refractive | Abbe |
|---|---|---|---|---|---|---|
| No. | Component | Curvature | Distance | Radius | Index | Number |
| S1 | First | −26.363 | 6.888 | 12.132 | 1.458 | 67.821 |
| S2 | Lens | −67.779 | 1.255 | 13.929 | | |
| S3 | Second | −85.136 | 7.316 | 14.253 | 1.458 | 67.821 |
| S4 | Lens | −46.837 | 0.500 | 15.341 | | |
| S5 | Third | 153.878 | 6.315 | 15.839 | 1.434 | 94.996 |
| S6 | Lens | −53.556 | 1.994 | 16.164 | | |
| S7 | Fourth | −59.823 | 4.000 | 16.168 | 1.458 | 67.821 |
| S8 | Lens | 145.903 | 2.547 | 16.683 | | |
| S9 | Fifth | −1614.988 | 6.568 | 17.054 | 1.434 | 94.996 |
| S10 | Lens | −43.770 | 0.501 | 17.518 | | |
| S11 | Sixth | 97.642 | 7.063 | 17.551 | 1.458 | 67.821 |
| S12 | Lens | −632.582 | 3.992 | 17.411 | | |
| S13 | Seventh | −55.845 | 4.000 | 17.251 | 1.458 | 67.821 |
| S14 | Lens | 51.785 | 1.614 | 17.625 | | |
| S15 | Eighth | 53.767 | 8.399 | 18.316 | 1.434 | 94.996 |
| S16 | Lens | −79.906 | 3.129 | 18.547 | | |
| S17 | Filter | Infinity | 2.658 | 18.429 | | |
| S18 | | Infinity | 100.000 | 18.388 | | |
| S19 | Surface to Be | | 0.000 | 14.138 | | |
| | Processed | | | | | |

Table 6 below illustrates characteristic values of the lens systems according to the first to fifth embodiments, and Tables 7 to 10 below show conditional expression values of the lens systems according to the first to fifth embodiments.

TABLE 6

| | First | Second | Third | Fourth | Fifth |
|---|---|---|---|---|---|
| Value | Embodiment | Embodiment | Embodiment | Embodiment | Embodiment |
| f1 | −99.075 | −99.049 | −99.089 | −99.161 | −99.293 |
| f2 | 213.344 | 213.879 | 213.995 | 213.964 | 214.238 |
| f3 | 92.191 | 92.320 | 92.352 | 92.381 | 92.424 |
| f4 | −91.956 | −91.988 | −91.995 | −91.993 | −91.980 |
| f5 | 103.896 | 103.630 | 103.595 | 103.583 | 103.567 |
| f6 | 184.690 | 185.137 | 185.111 | 185.127 | 185.061 |
| f7 | −57.853 | −57.914 | −57.925 | −57.927 | −57.930 |
| f8 | 75.775 | 75.581 | 75.550 | 75.537 | 75.518 |
| TTL | 171.340 | 169.596 | 169.185 | 168.970 | 168.738 |
| fb | 100.000 | 100.000 | 100.000 | 100.000 | 100.000 |

TABLE 7

| Conditional | First | Second | Third | Fourth | Fifth |
|---|---|---|---|---|---|
| Expression | Embodiment | Embodiment | Embodiment | Embodiment | Embodiment |
| f1/f8 | −1.307 | −1.310 | −1.312 | −1.313 | −1.315 |
| f2/f8 | 2.815 | 2.830 | 2.833 | 2.833 | 2.837 |
| f3/f8 | 1.217 | 1.221 | 1.222 | 1.223 | 1.224 |
| f4/f8 | −1.214 | −1.217 | −1.218 | −1.218 | −1.218 |
| f5/f8 | 1.371 | 1.371 | 1.371 | 1.371 | 1.371 |
| f6/f8 | 2.437 | 2.450 | 2.450 | 2.451 | 2.451 |
| f7/f8 | −0.763 | −0.766 | −0.767 | −0.767 | −0.767 |
| f1/f4 | 1.077 | 1.077 | 1.077 | 1.078 | 1.080 |
| f1/f7 | 1.713 | 1.710 | 1.711 | 1.712 | 1.714 |
| f2/f6 | 1.155 | 1.155 | 1.156 | 1.156 | 1.158 |
| f3/f5 | 0.887 | 0.891 | 0.891 | 0.892 | 0.892 |
| f2/(f3 + f5) | 1.088 | 1.091 | 1.092 | 1.092 | 1.093 |

TABLE 8

| Conditional | First | Second | Third | Fourth | Fifth |
|---|---|---|---|---|---|
| Expression | Embodiment | Embodiment | Embodiment | Embodiment | Embodiment |
| TTL/fb | 0.469 | 0.468 | 0.467 | 0.467 | 0.467 |
| TTL/f2 | 0.803 | 0.793 | 0.791 | 0.790 | 0.788 |
| TTL/f8 | 2.261 | 2.244 | 2.239 | 2.237 | 2.234 |

TABLE 9

| Conditional | First | Second | Third | Fourth | Fifth |
|---|---|---|---|---|---|
| Expression | Embodiment | Embodiment | Embodiment | Embodiment | Embodiment |
| R1/f5 | −0.254 | −0.254 | −0.254 | −0.255 | −0.255 |
| R16/f5 | −0.738 | −0.752 | −0.758 | −0.764 | −0.772 |
| (R1 + R16)/(R1 − R16) | −2.049 | −2.022 | −2.010 | −2.000 | −1.985 |
| (R6 + R7)/(R6 − R7) | −18.042 | −18.193 | −18.085 | −18.007 | −18.090 |

TABLE 10

| Conditional | First | Second | Third | Fourth | Fifth |
|---|---|---|---|---|---|
| Expression | Embodiment | Embodiment | Embodiment | Embodiment | Embodiment |
| SumV14/SumV58 | 0.917 | 0.917 | 0.917 | 0.917 | 0.917 |
| SumV35/SumV68 | 1.118 | 1.118 | 1.118 | 1.118 | 1.118 |
| SumVP/SumVN | 2.067 | 2.067 | 2.067 | 2.067 | 2.067 |

The present disclosure may improve the processing precision of a laser device using a femtosecond laser while reducing a processing deviation.

The present disclosure may improve the circularity of a laser device using a femtosecond laser.

While this disclosure includes specific embodiments, it will be apparent after an understanding of the disclosure of this application that various changes in form and details may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens system comprising:
a first lens having a negative refractive power;
a second lens having a refractive power and a concave object-side surface in a paraxial region thereof;
a third lens having a refractive power;
a fourth lens having a negative refractive power;
a fifth lens having a refractive power;
a sixth lens having a positive refractive power;
a seventh lens having a refractive power; and
an eighth lens having a positive refractive power,
wherein the first to eighth lenses are sequentially arranged in ascending numerical order along an optical axis of the lens system away from a light source toward an imaging plane of the lens system.

2. The lens system of claim 1, wherein an object-side surface of the first lens is concave in a paraxial region thereof.

3. The lens system of claim 1, wherein an object-side surface of the third lens is convex in a paraxial region thereof.

4. The lens system of claim 1, wherein an object-side surface of the fourth lens is concave in a paraxial region thereof.

5. The lens system of claim 1, wherein an object-side surface of the fifth lens is concave in a paraxial region thereof.

6. The lens system of claim 1, wherein an object-side surface of the sixth lens is convex in a paraxial region thereof.

7. The lens system of claim 1, wherein an object-side surface of the seventh lens is concave in a paraxial region thereof.

8. The lens system of claim 1, wherein an object-side surface of the eighth lens is convex in a paraxial region thereof.

9. A lens system comprising:
a first lens, a second lens, a third lens, a fourth lens, a fifth lens, a sixth lens, a seventh lens, and an eighth lens sequentially arranged in ascending numerical order along an optical axis of the lens system away from a light source toward an imaging plane of the lens system,
wherein the second lens and the third lens each have a positive refractive power, and
the lens system satisfies the following conditional expression:
$$- 1.5 < f 1 / f 8 < - 1.2$$
where f1 is a focal length of the first lens, and f8 is a focal length of the eighth lens.

10. The lens system of claim 9, wherein an object-side surface of the first lens is concave in a paraxial region thereof.

11. The lens system of claim 9, wherein an object-side surface of the second lens is concave in a paraxial region thereof.

12. The lens system of claim 9, wherein an object-side surface of the third lens above is convex in a paraxial region thereof.

13. The lens system of claim 9, wherein an object-side surface of the fourth lens is concave in a paraxial region thereof.

14. The lens system of claim 9, wherein an object-side surface of the fifth lens is concave in a paraxial region thereof.

15. The lens system of claim 9, wherein an object-side surface of the sixth lens is convex in a paraxial region thereof.

16. The lens system of claim 9, wherein an object-side surface of the seventh lens is concave in a paraxial region thereof.

17. The lens system of claim 9, wherein an object-side surface of the eighth lens is convex in a paraxial region thereof.
